(19) United States
(12) Patent Application Publication
(10) Pub. No.: US 2026/0306883 A1
(43) Pub. Date: Oct. 8, 2026

(54) DIELECTRIC HANGING SEAT

(71) Applicant: Freddy MORCILLO MUÑOZ, Cali (CO)

(72) Inventors: Freddy MORCILLO MUÑOZ, Cali (CO); Andres Fernando MONTES RODRÍGUEZ, El Cerrito (CO); Jhoan Steven RAMIREZ CHAVEZ, Palmira (CO)

(21) Appl. No.: 19/109,397

(22) PCT Filed: May 26, 2023
(86) PCT No.: PCT/IB2023/055394

§ 371 Date: Mar. 6, 2025

(30) Foreign Application Priority Data
May 26, 2022 (CO) NC2022/0007160

(51) Int. Cl. A62B 35/00; A47C 1/00; E04G 3/30

(52) U.S. Cl. CPC A62B 35/0012; A47C 1/00; E04G 3/30

(57) ABSTRACT

The present disclosure describes embodiments of a hanging dielectric seat for working at height, comprising a rigid base of dielectric material. The rigid base has a central section, two lateral ends projecting from the central section, and at least two holes, each hole being located in a lateral end. The dielectric seat also comprises a fastening element that includes a support strap designed to support a central section of the base, and a first connection strap and a second connection strap, each connection strap extending from a lateral end of the support strap and passing through a hole. The support strap is disposed on the underside of the rigid base, and the connection straps project upwards from the rigid base through the holes. In addition, the support strap and the connection straps are made of a textile material of dielectric filaments and are designed to connect to connection elements that allow the dielectric seat to hang.

### RELATED TECHNICAL FIELD

This disclosure relates to safety seats, belts, or harnesses and similar equipment for limiting the movement of the human body, especially in the event of a sudden change in movement. In particular, the present disclosure relates to hanging seats for working at height.

### DESCRIPTION OF PRIOR ART

Document KR20100114487A discloses a hanging scaffold chair that allows an operator to secure their possessions (e.g. tools, work supplies), and that prevents safety accidents due to falling objects. Said document mentions that the chair comprises a support stand and a mounting plate. The mounting plate is integrally fixed with the support stand. Furthermore, said document mentions a seat back formed on one side of the mounting plate, and mentions a loop and a postponement tube formed on the right and left side of the mounting plate.

Similarly, said document mentions a working rope and a life rope that are connected and fixed to the mounting plate by means of handles protruding from said mounting plate. Finally, said document describes a plurality of hooks arranged at each corner of the mounting plate.

On the other hand, document KR20130001291 mentions a safety seat for working on the outer wall of a building during repair or cleaning work. The safety seat includes a seat belt connected to handles that protrude from a seat plate. Said document mentions that the seat belt is connected to each corner of the seat plate. Said seat belt is fixed to the roof of the building to raise and lower the seat plate, keeping the seat horizontal while the operator is on board. Said document states that in the past, as support wooden boards were mainly used, but considering the high weight as well as the risk of damage, the document mentions that the base plate is made of aluminum, which is light, high-strength, and not prone to corrosion.

According to the above, the document mentions conductive metallic materials such as aluminum, and does not mention that the seat plate and strings are made of dielectric materials.

The document DELUXE 2 POINT SUSPENSION MIO CHAIR WITH PERMANENT WAIST BELT, 4 CLIPS, 2 TOOL HOLDERS AND CUSHION, retrieved from: https://www.window-cleaning-supply.com/deluxe-2-point-suspension-mio-chair-with-permanent-waist-belt-4-clips-2-tool-holders-and-cushion in May 2022, discloses a suspension chair that has a wood laminate base with perforations at its longitudinal ends. Said document shows a belt running through the holes in the base. A central section of the belt is arranged at the bottom of the base, confined by a plate that is attached to the base with metal rivets. Additionally, said document shows apparently metallic carabiners attached to the base. Therefore, the product disclosed by said document uses metallic elements.

### BRIEF DESCRIPTION OF THE DISCLOSURE

The present disclosure describes embodiments of a hanging dielectric seat for working at height, comprising a rigid base of dielectric material. The rigid base has a central section, two lateral ends projecting from the central section, and at least two holes, each hole being located in a lateral end. The dielectric seat also comprises a fastening element that includes a support strap designed to support a central section of the base, and a first connection strap and a second connection strap, each connection strap extending from a lateral end of the support strap and passing through a hole. The support strap is disposed on the underside of the rigid base, and the connection straps project upwards from the rigid base through the holes. In addition, the support strap and the connection straps are made of a textile material of dielectric filaments and are designed to connect to connection elements that allow the dielectric seat to hang.

In any of the embodiments of the dielectric seat described herein, the dielectric seat is suitable for safe work at height, ideal for transport because it is a lightweight product and has the strength to support the weight of a worker suspended at height.

### BRIEF DESCRIPTION OF THE DRAWINGS

FIG. 1 shows an exploded view of an embodiment of the dielectric seat, from above, showing details of some connection elements and ribs of the rigid base of said dielectric seat.

FIG. 2 shows an exploded view of an embodiment of the dielectric seat, from above, showing details of a fastening element having a support strap with two connection straps, and also showing a detail of a saddle of the dielectric seat.

FIG. 3 shows an embodiment of the dielectric seat, from below, showing details of some connection elements and straps of said dielectric seat.

### DETAILED DESCRIPTION OF THE INVENTION

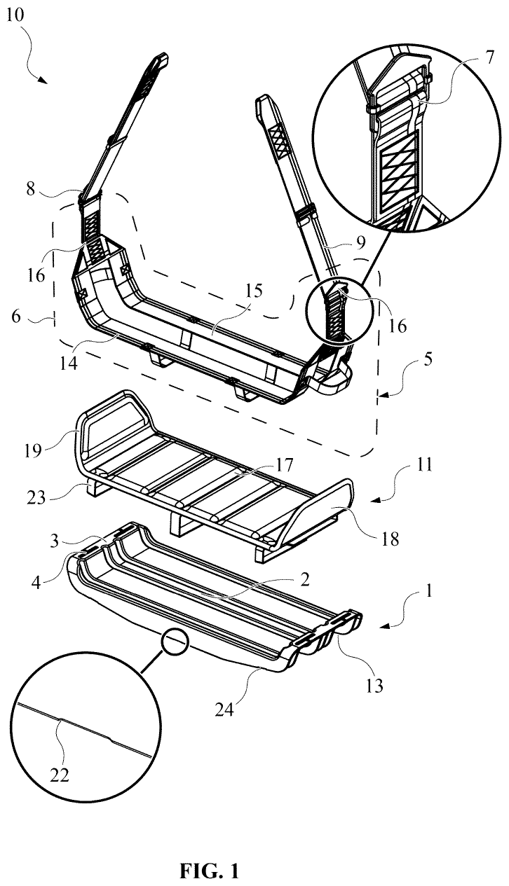

The present disclosure describes embodiments of a hanging dielectric seat (10) for working at height, comprising a rigid base (1) of dielectric material. Referring to FIG. 1, the rigid base (1) has a central section (2), two lateral ends (3) projecting from the central section (2), and at least two holes (4), each hole (4) being located in a lateral end (3). The dielectric seat (10) also comprises a fastening element (5) that includes a support strap (6) designed to support a central section (2) of the base (2), and a first connection strap (8) and a second connection strap (9), each connection strap (8, 9) extending from a lateral end of the support strap (6) and passing through a hole (4). The support strap (6) is disposed on the underside of the rigid base (1) and the connection straps (8, 9) project upwards from the rigid base (1) through the holes (4). Furthermore, the support strap (6) and the connection straps (8, 9) are made of a textile material of dielectric filaments and are designed to connect to connection elements (7) that allow the dielectric seat to hang (10).

One of the technical advantages of the dielectric seat (10) is that its elements and pieces are made of dielectric materials, which protects the user against electric shocks.

On the other hand, the support strap (6) in combination with the first connection strap (8) and the second connection strap (9) fasten the rigid base (1) so that, in the event of the rigid base (1) failing, for example, breaking or cracking, the support strap (6) supports the user's weight and keeps him safe.

The rigid base (1) may be made of a dielectric polymeric material, which can be selected from the group including polymethyl methacrylate (PMMA), polyvinyl chloride (PVC), chlorinated polyvinyl chloride (CPVC), polyethylene terephthalate (PET), polyamides (PA) (e.g. PA12, PA6, PA66), polychlorotrifluoroethylene (PCTFE), polyvinylidene fluoride (PVDF), polyethylene tetrafluoride (PTFE), ethylene-chlorotrifluoroethylene (ECTFE), plastics (polyester, vinylester, epoxy, vinyl resins) reinforced with fibers (e.g. glass, aramid, polyester), cross-linked polyethylene (PEX), combinations thereof, copolymers thereof, and similar thermoplastic or thermosetting plastics known to a person of ordinary skill in the art.

In turn, the support strap (6), the first connection strap (8) and the second connection strap (9) are made of dielectric textile materials, such as threads, filaments, and combinations thereof. One of the advantages of using polymer filaments, for example, polypropylene (PP), polyamides (PA 6, PA 6.6.), aramids, or polyvinyl chloride (PVC), is that these filaments are usually obtained by injection and have better tensile strength than many threads made of interlaced fibers.

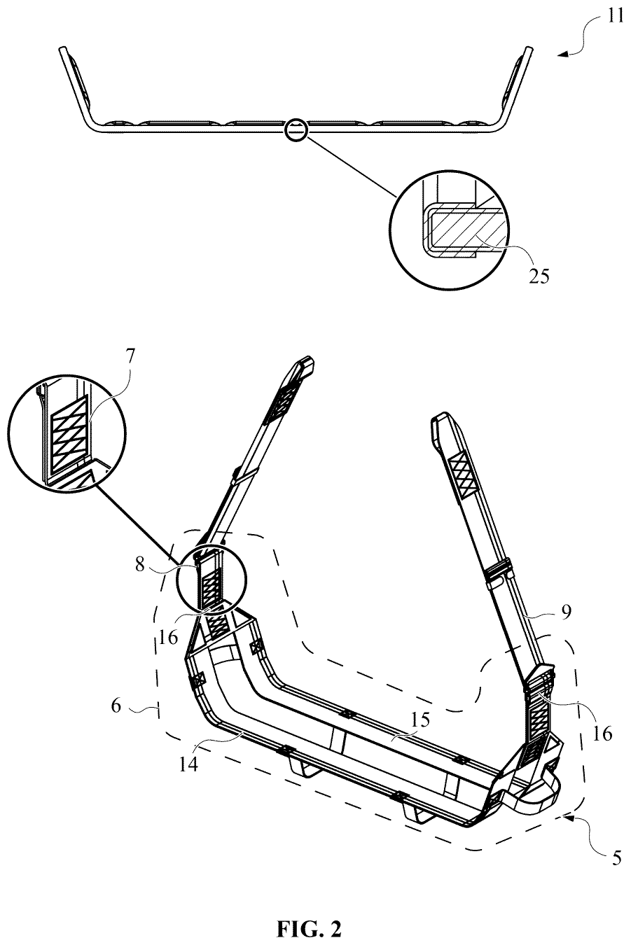

Referring to FIG. 2, the straps (6, 8, 9) preferably have zig-zag stitching patterns, or similar alternating patterns, which allow for reinforcement of said straps (6, 8, 9). The stitching patterns can be disposed in the areas where the straps (6, 8, 9) connect to each other, for example, at the connection point of the support strap (6) with the second connection strap (9) and at the connection point of the support strap (6) with the first connection strap (8). One of the technical advantages of stitching patterns is that they enhance the structural connection of the straps and improve resistance to shear stresses, weight overloads, and/or impact force (e.g., in case of an abrupt ascent or descent of the dielectric seat (10)).

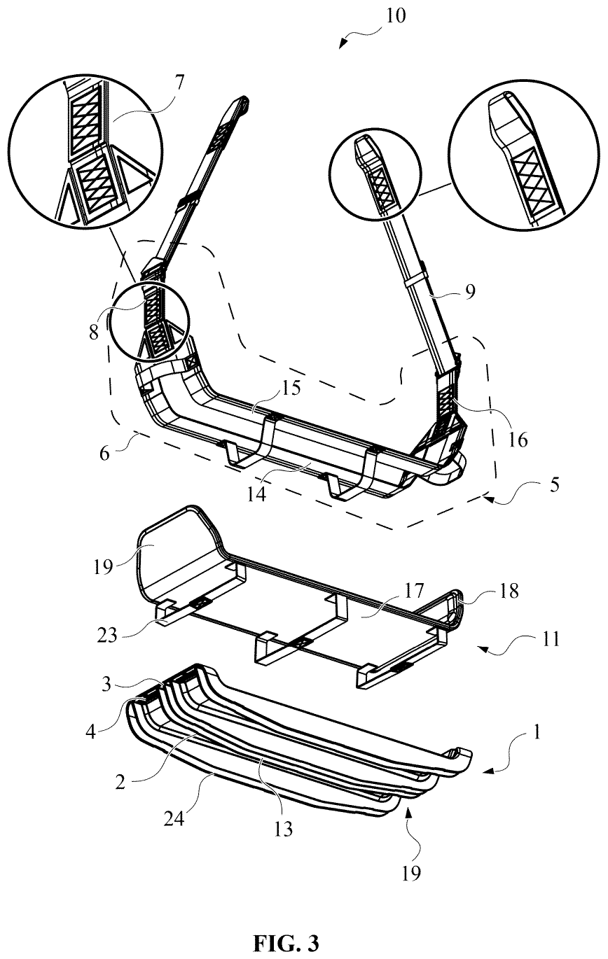

Referring to FIG. 1 and FIG. 3, in any of the embodiments of the dielectric seat (10) disclosed herein, the rigid base (1) may include rigidizing elements disposed on an underside of the rigid base (1). Said rigidizing elements may have different geometries and extend in different directions from the rigid base (1) in order to increase its rigidity and moment of inertia with respect to its rotation axes and stress application.

For example, such rigidizing elements may be selected from the group including channels, holes, high relief patterns, low relief patterns, beam sections, joists, variable thickness sections, sections, patterns, and similar rigidizing shapes known to a person of ordinary skill in the art, and combinations thereof.

One or more of the rigidizing elements may have a cross section that can be selected from the group including squares, triangles, circles, rectangles, pentagons, trapezoids, ellipses, rhombuses, hexagons, heptagons, octagons, decagons, other regular or irregular geometric figures known to a person of ordinary skill in the art, and combinations thereof.

Referring to FIG. 3, in any of the embodiments of the dielectric seat (10) disclosed herein, the rigid base (1) may include a channel (13) extending between the holes (4), along an underside of the central section (2) of the rigid base (1), wherein the channel (13) houses the support strap (6).

The channel (13) allows to restrict the movement of the support strap (6) in the transverse direction of the rigid base (1), which provides improved stability for the user of the dielectric seat (10), which in turn implies better safety. Furthermore, the channel (13) is a rigidizing element that increases the moment of inertia of the rigid base (1) and provides it with better mechanical resistance conditions. Similarly, the channel (13) allows to reduce the total mass of the rigid base (1) compared to a solid rigid base (1).

Referring to FIG. 2 and FIG. 3, in any of the embodiments of the dielectric seat (10) disclosed herein, the support strap (6) may be formed by a first longitudinal section (14), a second longitudinal section (15) parallel to the first longitudinal section (14), and two end sections (16) between which the first longitudinal section (14) and the second longitudinal section (15) extend. The end sections (16) form the lateral end of the support strap (6) which connects to the connection straps (8, 9).

Thus, the support strap (6) can create a larger gripping surface of the rigid base (1), thereby improving the stability and safety of the dielectric seat (10).

Referring to FIG. 3, in some of the embodiments of the dielectric seat (10) disclosed herein, the rigid base (1) may include two channels (13), each channel (13) extending between two of the holes (4) of the rigid base (1) which are spaced apart from each other in the longitudinal direction of said rigid base (1), wherein each channel (13) houses a longitudinal section (14, 15) of the support strap (6). In these embodiments, the channels (13) limit the movement of the first longitudinal section (14) and the second longitudinal section (15) of the support strap (6), thereby further improving the stability and safety of the dielectric seat (10) compared to the case in which there is a support strap (6) with longitudinal sections (14, 15) but without channels (13) housing these longitudinal sections (15, 16). Furthermore, by increasing the number of channels (13), the rigid base (1) obtains greater rigidity and reduces its weight.

In any of the embodiments of the dielectric seat (10) disclosed herein, said dielectric seat (10) may also include a saddle (11) disposed on the rigid base (1), wherein the saddle (11) includes removable connection elements (23) designed to connect the saddle (11) to the rigid base (1).

Referring to FIG. 2, the saddle (11) preferably has a padding (25) and includes at least one sheet or layer of a soft material that can be selected from the group including natural rubber, synthetic rubber, thermoplastic elastomers, vulcanized rubber, thermoplastic polyurethane, thermosetting polyurethanes, elastomeric materials, polyisoprene, polybutadiene, styrene-butadiene rubber, butyl rubber, nitrile rubber foams, polyurethane foams, D15 foam, D18 foam, D20 foam, D23 foam, D26 foam, D26 antibacterial foam, D30 foam, D36 foam, fire foams, polypropylene memory foam, hemp, polypropylene, fabric, plastic, PET, epoxy resins, latex, cellulosic foam, polyethylene foam, polyethylene honeycomb film, polyurethane foam, elastomeric foam, aerogel, any other soft, padded, or softened material known to a person of ordinary skill in the art, and combinations thereof.

For example, the saddle (11) may be a sandwich laminate that includes layers such as foams and fabrics joined together with seams.

Furthermore, in any of the embodiments of the dielectric seat (10), the rigid base (1) may include lateral sections inclined upwards and outwards from its central area. One of the technical advantages of this geometry of the rigid base (1) is that the safety of the dielectric seat (10) is improved as it restricts the mobility of the user in the longitudinal direction of the rigid base (1), thereby avoiding an imbalance that could put the user at risk of falling or create a pendulum-like movement of the dielectric seat (10).

In any of the embodiments of the dielectric seat (10) disclosed herein that include the saddle (11) and the rigid base (1) with lateral sections inclined upwards, said saddle (11) may have a rectangular central section (17) disposed on the rigid base (1), and two end sections (18) projecting upwards from the rectangular central section (17). In this way, the lateral sections inclined upwards of the rigid base (1) are covered and padded, which improves user comfort.

In any of the embodiments of the dielectric seat (10) disclosed herein, the connection elements (7) may have a metal core covered by a dielectric polymeric material. In this way, the metal components are electrically isolated and the user's safety against accidental electric shocks is guaranteed.

Referring to FIG. 3, in some of the embodiments of the dielectric seat (10) disclosed herein, the rigid base (1) may have at least two channels (13) disposed on an underside (19) of the rigid base (1), each channel (13) extending between holes (4) of the rigid base (1) spaced apart from each other in the longitudinal direction of said rigid base (1). Each channel (13) houses a longitudinal section (15, 16) of the support strap (6).

Moreover, referring to FIG. 1, the dielectric seat (10) may have a plurality of grooves (20) located on a topside (21) of the rigid base (1) and a plurality of ribs (22) extending orthogonally to the channels (13) from edges (24) of the rigid base (1). These embodiments combine the effects of weight reduction and increased rigidity of channels (13) and ribs (22). In particular, this geometry is desirable when the rigid base (1) is manufactured by injection in thermoplastic polymeric materials such as PVC, PP, PET, PCTFE, and PTFE.

However, in the case that the rigid base (1) is manufactured from plastics (polyester, vinylester, epoxy, vinyl resins) reinforced with fibers (e.g. glass, aramid, polyester), the rigid base (1) may include sections reinforced with core materials. In this way, the moment of inertia can also be increased and areas of the rigid base (1) with high stress can be locally reinforced.

Such core materials may be selected from the group including hexagonal honeycomb-type honeycombs, expanded foams with microspheres (Lantor® Coremat®, VitelMat®, or their technical equivalents), reinforcing foams, balsa wood, other core materials for fiber and resin laminates known to a person of ordinary skill in the art, and combinations thereof.

### Example 1

A dielectric seat (10) was designed and built for safe work at height, consisting of a rigid base (1) manufactured by means of an injection process in a thermoplastic polymeric material, in this case polypropylene (PP), which has a bending resistance of 3000N without causing the piece to break. The rigid base (1) of example 1 has 4 grooves (20) extended longitudinally, and with a semicircular cross section. Furthermore, the rigid base (1) has a plurality of ribs (22) extending orthogonally to the channels (13) from edges (24) of the rigid base (1).

The rigid base (1) has at its lateral ends two rectangular holes (4) located equidistant from the center, and located in the end sections (18) of the rigid base (1). A 4.5 mm wide connection strap (8, 9) passes through each hole (4). In particular, the end sections (18) of the rigid base (1) are two curves on each side inclined at an angle of 60 degrees outwards. Furthermore, each of the end sections (18) at a central back and front portion has a centered rectangular shape that decreases in size, giving a slanted shape to the outer corners where the curve is located.

At the bottom, there are seven rib reinforcements (22) forming two holes (4) that allow the passage of two auxiliary connection straps (8, 9), which extend from the support strap (6) surrounding the rigid base (1) in its transverse direction. The auxiliary connection straps (8, 9) are made of high tenacity polyester with a resistance of 5000 pounds to tension, which are designed to form a harness sewn with 100% high tenacity polyester thread, with a locking machine and lock stitches, which prevents the product from coming undone during use. The joint of the ends of the connection straps (8, 9) is thus sewn, using a zigzag technique to leave each connection strap (8, 9) positioned within the base (1) and between the ribs (22) in the form of a rail.

In each connection strap (8, 9), a distal section is folded at each end in a trapezoidal manner where triangular seams are made on each side. In the middle of each connection strap (8, 9) there is a section of sewn strap with a zigzag stitch that is attached to a connection element (7), which in this example includes a dielectric regulating buckle composed of an inner steel core and coated with polyacetal (POM) with a tensile strength of 5000 pounds. The connection element (7) also includes a tensioning buckle and a retainer.

In a central area of the connection element (7) a distal section of a support strap passes, which in this case is similar in manufacture and materials to the connection straps (8, 9). The support strap has a loop sewn with a zigzag stitch at its end, and wherein the tensioning buckle of the connection element (7) is disposed, which allows the adjustment of the length of the connection straps (8, 9) and the support strap to customize them to the height required by the user. In turn the retainer of the connection element (7) is designed to block the extension of the straps selected by the user.

### Example 2

The dielectric seat (10) of example 1 was modified, including a saddle (11). The saddle (11) has padding (25) on top. Furthermore, the saddle (11) is connected to the rigid base (1) by means of three removable connection elements (23), which in this example are similar in manufacture and materials to the connection straps (8, 9). The removable connection elements (23) are located at the ends and in the center of the saddle (11), as well as from the front and back longitudinally. Each removable connection element (23) has zigzag stitching at the ends that are attached to the padding (25) and ends with hook-and-loop fasteners, commercially known as “Velcro,” or functionally similar elements. The hook-and-loop fasteners have male and female components to secure the saddle (11) to the bottom of the dielectric seat (10).

The padding (25) of the saddle (11) is made up of three sandwich-shaped layers: in the center there is a foam and at the top and bottom a fabric sewn at its edges by a 1.5 mm bias that creates a rectangular shape in the center and a rounded trapezoid shape at the ends of the saddle (11).

It should be understood that the present invention is not limited to the embodiments described and illustrated herein. As will be apparent to one skilled in the art, there are potential variations and modifications that do not depart from the spirit of the invention, which is only defined by the following claims.

1. A hanging dielectric seat (10) for working at height, comprising:
a rigid base (1) of a dielectric material, wherein the rigid base (1) has:
a central section (2);
two lateral ends (3) projecting from the central section (2), and
at least two holes (4), each hole (4) located in a lateral end (3);
a fastening element (5) that includes:
a support strap (6) designed to support a central section (2) of the base (1), and
a first connection strap (8) and a second connection strap (9), each connection strap (8, 9) extending from a lateral end of the support strap (6) and passing through a hole (4),
wherein the support strap (6) is disposed on the underside of the rigid base (1) and the connection straps (8, 9) project upwards from the rigid base (1) through the holes (4), and
wherein the support strap (6) and the connection straps (8, 9) are made of a textile material of dielectric filaments and are designed to connect to connection elements (7) that allow the dielectric seat to hang (10).

2. The seat of claim 1, wherein the rigid base (1) includes rigidizing elements disposed on an underside of the rigid base (1).

3. The seat of claim 2, wherein the rigid base material (1) is a polymeric dielectric material.

4. The seat of claim 1, wherein the rigid base (1) includes a channel (13) extending between the holes (4), along an underside of the central section (2) of the rigid base (1), wherein the channel (13) houses support strap (6).

5. The seat of claim 1, wherein the support strap (6) is comprised of:
a first longitudinal section (14);
a second longitudinal section (15) parallel to the first longitudinal section (14);
two end sections (16) between which the first longitudinal section (14) and the second longitudinal section (15) extend,
wherein the end sections (16) form the lateral end of the support strap (6) which connects to the connection straps (8, 9).

6. The seat of claim 5, wherein the rigid base (1) includes two channels (13), each channel (13) extending between two of the holes (4) of the rigid base (1) which are spaced apart from each other in the longitudinal direction of said rigid base (1),
wherein each channel (13) houses a longitudinal section (15, 16) of the support strap (6).

7. The seat of claim 1, further comprising a saddle (11) with padding (25) disposed on the rigid base (1), wherein the saddle (11) includes removable connection elements (23) designed to connect the saddle (11) to the rigid base (1).

8. The seat of claim 7, wherein the saddle (11) has a rectangular central section (17) disposed on the rigid base (1), and two end sections (18) projecting upwards from the rectangular central section (17).

9. The seat of claim 1, wherein the connection elements (7) have a metal core covered by a dielectric polymeric material.

10. The seat of claim 1, wherein the rigid base (1) has:
two channels (13) disposed on an underside (19) of the rigid base (1), each channel (13) extending between holes (4) of the rigid base (1) spaced apart from each other in the longitudinal direction of said rigid base (1),
wherein each channel (13) houses a longitudinal section (15, 16) of the support strap (6);
a plurality of grooves (20) located on an topside (21) of the rigid base (1); and
a plurality of ribs (22) extending orthogonally to the channels (13) from edges (24) of the rigid base (1).
